(19) United States
(12) Patent Application Publication
(10) Pub. No.: US 2016/0276124 A1
(43) Pub. Date: Sep. 22, 2016

(54) X-RAY TUBE

(71) Applicants: Kabushiki Kaisha Toshiba, Minato-ku (JP); Toshiba Electron Tubes & Devices Co., Ltd., Otawara-shi (JP)

(72) Inventor: Takeshi KATO, Nasushiobara (JP)

(73) Assignees: Kabushiki Kaisha Toshiba, Minato-ku (JP); Toshiba Electron Tubes & Devices Co., Ltd., Otawara-shi (JP)

(21) Appl. No.: 15/068,700

(22) Filed: Mar. 14, 2016

(30) Foreign Application Priority Data
Mar. 17, 2015 (JP) 2015-053115

(51) Int. Cl. H01J 35/06; H01J 35/08

(52) U.S. Cl. CPC H01J 35/06; H01J 35/08

(57) ABSTRACT

According to one embodiment, an X-ray tube includes a cathode, an anode target and an envelope. The cathode includes an insulating member, a conductive line, a pin assembly, a filament, a focusing electrode, and a terminal assembly. The conductive line is formed on the insulating member. The pin assembly includes a pin and a first sleeve. The terminal assembly is fixed to the insulating member, is supporting the filament, and is electrically connecting the filament to the conductive line.

### CROSS-REFERENCE TO RELATED APPLICATIONS

This application is based upon and claims the benefit of priority from Japanese Patent Application No. 2015-053115, filed Mar. 17, 2015, the entire contents of which are incorporated herein by reference.

### FIELD

Embodiments described herein relate generally to an X-ray tube.

### BACKGROUND

In general, an X-ray tube assembly is used in a medical diagnosis system, an industrial diagnosis system or the like. The X-ray tube assembly comprises an X-ray tube which radiates X-rays, etc. The X-ray tube comprises a cathode including a focusing electrode and a filament which emits electrons, an anode with which the electrons emitted from the filament collide to radiate X-rays, and an envelope which accommodates the cathode and the anode. Electrons traveling from the cathode toward the anode are accelerated by the potential difference between the cathode and the anode, and are focused by the focusing electrode.

The focusing electrode, terminal assemblies and pin assemblies are attached to an insulating member, and electrically insulated from each other by the insulating member. The terminal assemblies support the filament. The pin assemblies are also attached to the envelope. Metallic thin wires (or metallic foil bands) are welded to the terminal assemblies and the pin assemblies, thus electrically connecting the terminal assemblies and the pin assemblies to each other. A current and a voltage are supplied and applied to the filament through the pin assemblies, the metallic thin wires and the terminal assemblies.

### BRIEF DESCRIPTION OF THE DRAWINGS

FIG. 1 is a schematic configuration view showing an X-ray tube according to an embodiment.

FIG. 2 is a schematic top view showing part of the X-ray tube as shown in FIG. 1, and also showing a cathode.

FIG. 3 is a cross-sectional view taken along line III-III in FIG. 2, and showing part of the X-ray tube and also part of an envelope.

FIG. 4 is a cross-sectional view taken along line IV-IV in FIG. 2, and showing part of the X-ray tube and also part of the envelope.

FIG. 5 is a schematic view showing part of a first modification of the above X-ray tube and also showing a cathode.

FIG. 6 is a cross-sectional view taken along line VI-VI in FIG. 5, and showing part of the X-ray tube and also part of an envelope.

FIG. 7 is a cross-sectional view taken along line VII-VII in FIG. 5, and showing part of the X-ray tube and also part of the envelope.

FIG. 8 is a schematic view showing part of a second modification of the above X-ray tube and also showing a cathode.

FIG. 9 is a schematic view showing part of a third modification of the above X-ray tube and also showing a cathode.

FIG. 10 is a cross-sectional view showing part of a fourth modification of the X-ray tube, and also showing that a sleeve of a terminal assembly is crimped in an insulating plate.

### DETAILED DESCRIPTION

In general, according to one embodiment, there is provided X-ray tube comprising: a cathode including: an insulating member; a conductive line formed of metal and formed on the insulating member; a pin assembly including a pin having a conductive property and a first sleeve which has a conductive property, is fixed to the insulating member, guides the pin, is fixing the pin, and electrically connects the pin to the conductive line; a filament configured to emit electrons; a focusing electrode configured to focus the electrons emitted from the filament; and a terminal assembly having a conductive property, fixed to the insulating member, supporting the filament, and electrically connecting the filament to the conductive line; an anode target with which the electrons emitted from the cathode collide to generate X-rays; and an envelope which accommodates the insulating member, the conductive line, the first sleeve, the filament, the focusing electrode, the terminal assembly and the anode target, and to which the pin is attached.

Embodiments will be described with reference to the accompanying drawings. The disclosure is a mere example, and arbitrary change of gist which can be easily conceived by a person of ordinary skill in the art naturally falls within the inventive scope as long as the subject matter of the embodiments is maintained. To better clarify the explanations, the drawings may pictorially show width, thickness, shape, etc., of each portion as compared with an actual aspect, but they are mere examples and do not restrict the interpretation of the invention. In the present specification and drawings, after structural elements are each explained once with reference to the drawings, there is a case where their explanations will be omitted as appropriate, and those identical to or similar to the explained structural elements will be denoted by the same reference numbers, respectively, as the explained structural elements.

### Embodiment

An X-ray tube according to an embodiment will be explained in detail.

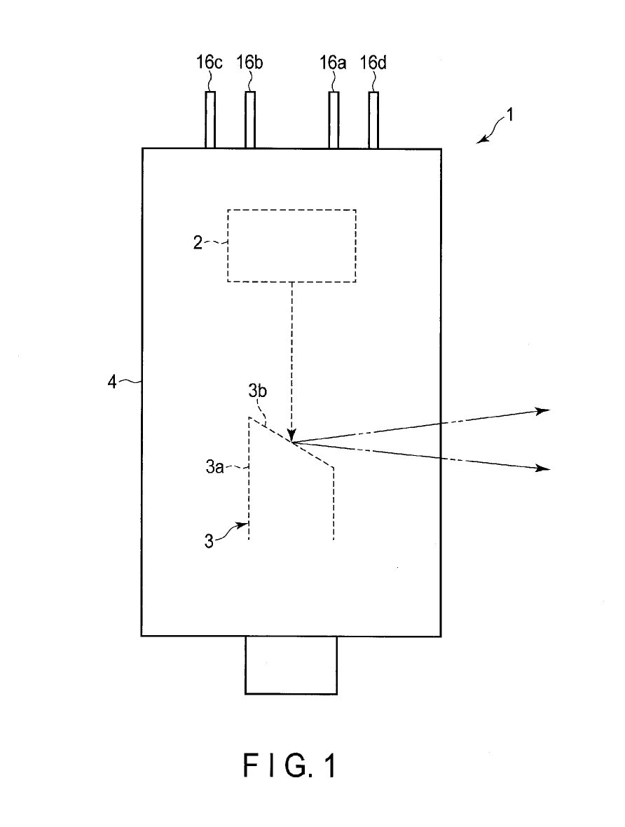

As shown in FIG. 1, an X-ray tube 1 is a stationary anode X-ray tube. The X-ray tube 1 comprises a cathode 2, an anode target 3 and an envelope 4. The cathode 2 emits electrons (thermal electrons).

The anode target 3 is provided in the envelope 4, and separated from the cathode 2. The relative position of the anode target 3 with respect to the cathode 2 and the envelope 4 is fixed. The anode target 3 comprises a target body 3a and a target surface 3b. The target surface 3b is provided as a surface of the target body 3a which faces the cathode 2. When electrons collide with the target surface 3b, at the target surface 3b, a focal spot is formed from which X-rays are generated. The target body 3a and the target surface 3b are formed of metal having a high heat resistance. The target body 3a can be formed of material having a lower heat resistance than that of the target surface 3b. In the embodiment, the target body 3a is formed of copper, and the target surface 3b is formed of a tungsten alloy.

The envelope 4 is formed of a combination of metal or glass or a combination of metal and glass. The envelope 4 is formed in the shape of a cylinder having end portions which are both closed. The envelope 4 is provided with an X-ray transmission window which transmits X-rays. The envelope 4 is hermetically closed, and is kept evacuated.

The envelope 4 accommodates an insulating plate 11, conductive lines 13, sleeves 17, a filament coil 21, a focusing electrode 23, terminal assemblies 25 and the anode target 3, to be described later. To the envelope 4, cathode pins 16 to be described later are attached.

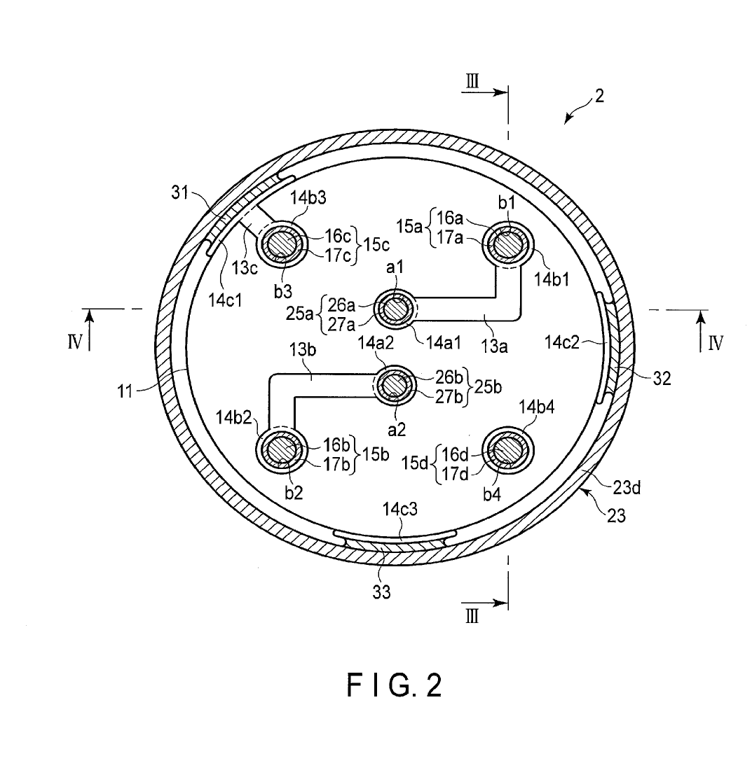

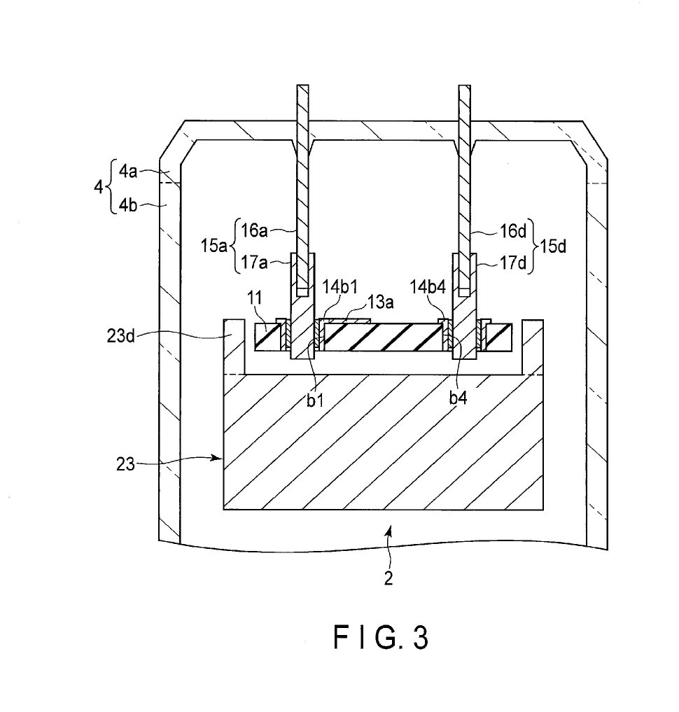

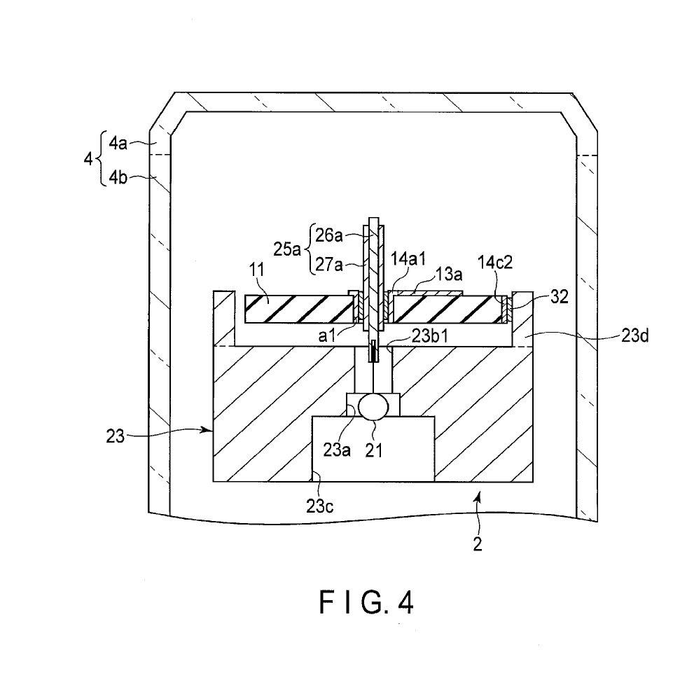

As shown in FIGS. 2 to 4, the cathode 2 comprises the insulating plate 11, which is provided as an insulating member, the conductive lines 13, conductive layers 14, pin assemblies 15, the filament coil 21, which is provided as a filament, the focusing electrode 23 and the terminal assemblies 25.

The insulating plate 11 is formed of an insulating material, for example, an insulating ceramics, and is also formed discoid. The insulating plate 11 includes through holes formed therein. Those through holes are separated from each other. In the embodiment, in the insulating plate 11, two through holes a1 and a2 are formed for the terminal assemblies 25, and four through holes b1, b2, b3 and b4 are formed for the pin assemblies 15.

The conductive lines 13 and the conductive layers 14 are formed of metal, and provided on the insulating plate 11. As examples of the above metal, nickel (Ni), gold (Au), silver (Ag), aluminum (Al), copper (Cu), molybdenum (Mo), etc., are present. Furthermore, in the embodiment, the conductive lines 13 and the conductive layers 14 are formed of metalized layers which will be described in detail later.

The conductive layers 14 comprise conductive layers 14a1, 14a2, 14b1, 14b2, 14b3 and 14b4 formed in the through holes a1, a2, b1, b2, b3 and b4 and conductive layers 14c1, 14c2 and 14c3 formed on an outer peripheral wall of the insulating plate 11. The conductive layers 14a1, 14a2, 14b1, 14b2, 14b3 and 14b4 continuously extend from inner peripheral walls of the holes to a surface of the insulating plate 11. It should be noted that the above surface of the insulating plate 11 faces a lid portion 4a to be described later. The conductive layer 14c1 is located close to the conductive layer 14b3. The conductive layers 14c1, 14c2 and 14c3 are separated from each other.

The conductive lines 13 comprise conductive lines 13a, 13b and 13c. The conductive line 13a is connected to the conductive layers 14a1 and 14b1. The conductive line 13b is connected to the conductive layers 14a2 and 14b2. The conductive line 13c is connected to the conductive layers 14b3 and 14c1. Referring to FIG. 2, the conductive line 13a is formed in a laterally inverted L-shape, the conductive line 13b is formed in a vertically inverted L-shape, and the conductive line 13c is linearly shaped.

Before attaching the pin assemblies 15 and the terminal assemblies 25 to the insulating plate 11, and also before fixing the focusing electrode 23 to the insulating plate 11, the conductive lines 13 and the conductive layers 14 are formed in advance on the insulating plate 11.

The pin assemblies 15 include cathode pins 16 provided as pins and sleeves 17 provided as first sleeves. The cathode pins 16 have a conductive property. In the embodiment, the cathode pins 16 are formed of metal and also formed in the shape of a rod. The cathode pins 16 are attached to the lid portion 4a of the envelope 4. In the embodiment, the lid portion 4a and main body 4b of the envelope 4 are formed of glass. The cathode pins 16 are fused and vacuum-tightly connected to the lid portion 4a, and one end portion of each of the cathode pins 16 is located outside the envelope 4. The sleeves 17 have a conductive property, are fixed to the insulating plate 11, guide the cathode pins 16, and are fixing the cathode pins 16. In the embodiment, the sleeves 17 are formed of metal and in the shape of a rod, and include hole portions for guiding the cathode pins 16.

The lid portion 4a is fused and vacuum-tightly connected to the main body 4b of the envelope 4. In the embodiment, the lid portion 4a is connected to the main body 4b, with the cathode pins 16, which are attached to the lid portion 4a, inserted in the hole portions of sleeves 17. Then, current is made to flow in the cathode pins 16, thereby resistance-welding the cathode pins 16 to the sleeves 17.

In the embodiment, the pin assemblies 15 comprise four pin assemblies 15a, 15b, 15c and 15d.

The pin assembly 15a includes a cathode pin 16a and a sleeve 17a. The sleeve 17a electrically connects the cathode pin 16a to the conductive line 13a. In the embodiment, the sleeve 17a is located in a through hole b1, and brazed to the conductive layer 14b1. Thereby, the sleeve 17a is fixed to the insulating plate 11, and electrically connected to the conductive layer 14b1. The cathode pin 16a is fixed to and electrically connected to the sleeve 17a by resistance welding.

The pin assembly 15b includes a cathode pin 16b and a sleeve 17b. The sleeve 17b electrically connects the cathode pin 16b to the conductive line 13b. In the embodiment, the sleeve 17b is located in a through hole b2, and brazed to the conductive layer 14b2. Thereby, the sleeve 17b is fixed to the insulating plate 11, and electrically connected to the conductive layer 14b2. The cathode pin 16b is fixed to and electrically connected to the sleeve 17b by resistance welding.

The pin assembly 15c includes a cathode pin 16c and a sleeve 17c. The sleeve 17c electrically connects the cathode pin 16c to the conductive line 13c. In the embodiment, the sleeve 17c is located in a through hole b3, and brazed to the conductive layer 14b3. Thereby, the sleeve 17c is fixed to the insulating plate 11, and electrically connected to the conductive layer 14b3. The cathode pin 16c is fixed to and electrically connected to the sleeve 17c by resistance welding.

The pin assembly 15d includes a cathode pin 16d and a sleeve 17d. In the embodiment, the sleeve 17d is located in a through hole b4, and brazed to the conductive layer 14b4. Thereby, the sleeve 17d is fixed to the insulating plate 11, and electrically connected to the conductive layer 14b4. The cathode pin 16d is fixed to and electrically connected to the sleeve 17d by resistance welding.

The filament coil 21 is formed to extend linearly. In the embodiment, the filament coil 21 extends substantially parallel to a line between the through holes a1 and a2. The filament coil 21 is formed of material containing metal, for example, tungsten, as a main ingredient.

The focusing electrode 23 is cylindrically formed, and includes a groove portion 23a, hole portions 23b1 and 23b2, and a groove portion 23c. The groove portion 23a is open on an anode target side where the anode target 3 is located, and the filament coil 21 is provided in the groove portion 23a. The groove portion 23a is shaped in the accordance with the shape of the filament coil 21. In the embodiment, the groove portion 23a extends in parallel with the filament coil 21. It should be noted that the filament coil 21 is located apart from an inner surface (bottom surface) of the groove portion 23a. The hole portions 23b1 and 23b2 communicate with the groove portion 23a. The hole portion 23b1 is located opposite to the through hole a1, and the hole portion 23b2 is located opposite to the through hole a2. In the hole portions 23b1 and 23b2, the terminal assemblies 25 and extension portions which are end portions of the filament coil 21 are located. The groove portion 23c is open on an anode target side where the anode target 3 is located, and forms an electrical potential distribution to converge electrons emitted from the filament coil 21.

The focusing electrode 23 is fixed to the insulating plate 11. To be more specific, in the embodiment, the focusing electrode 23 is fixed to the insulating plate 11 at three positions by brazing using solder members 31, 32 and 33. The focusing electrode 23 includes an annular portion 23d which surrounds the outer peripheral wall of the insulating plate 11. The solder member 31 is located between the annular portion 23d and the conductive layers 14c1, and soldered to the annular portion 23d and the conductive layers 14c1. The solder member 32 is located between the annular portion 23d and the conductive layers 14c2, and soldered to the annular portion 23d and the conductive layers 14c2. The solder member 33 is located between the annular portion 23d and the conductive layers 14c3, and soldered to the annular portion 23d and the conductive layers 14c3.

Also, the focusing electrode 23 is electrically connected to the cathode pin 16c. To be more specific, in the embodiment, the focusing electrode 23 is electrically connected to the cathode pin 16c, with the following elements interposed between them: the solder member 31; the conductive layers 14c1; the conductive line 13c; the conductive layer 14b3; a solder member (a solder member soldered to the conductive layer 14b3 and the sleeve 17c); and the sleeve 17c.

The terminal assemblies 25 have a conductive property, and is fixed to the insulating plate 11 to support the filament coil 21. The terminal assemblies 25 electrically connect the filament coil 21 to the conductive lines 13a and 13b.

The terminal assemblies 25 include filament terminals 26 provided as terminals and sleeves 27 provided as second sleeves. The filament terminals 26 have a conductive property. In the embodiment, the filament terminals 26 are formed of metal and also formed in the shape of a rod. The filament terminals 26 support the extension portions of the filament coil 21, and are electrically connected to the extension portion. It should be noted that the filament coil 21 is fixed to the filament terminals 26 by welding such as laser beam welding. The sleeves 27 have a conductive property, are fixed to the insulating plate 11, guides the filament terminals 26, and are fixing the filament terminals 26. The sleeves 27 electrically connect the filament terminals 26 to the conductive lines 13a and 13b. In the embodiment, the sleeves 27 are formed of metal and cylindrically formed, and include hole portions for guiding the filament terminals 26.

In the embodiment, the terminal assemblies 25 comprise two terminal assemblies 25a and 25b.

The terminal assembly 25a includes a filament terminal 26a and a sleeve 27a. The sleeve 27a electrically connects the filament terminal 26a to the conductive line 13a. In the embodiment, the sleeve 27a is located in the through hole a1, and brazed to the conductive layer 14a1. Thereby, the sleeve 27a is fixed to the insulating plate 11, and electrically connected to the conductive layer 14a1. The filament terminal 26a supports one of the extension portions of the filament coil 21. Also, the filament terminal 26a is fixed to and electrically connected to the sleeve 27a by resistance welding.

The terminal assembly 25b includes a filament terminal 26b and a sleeve 27b. The sleeve 27b electrically connects the filament terminal 26b to the conductive line 13b. In the embodiment, the sleeve 27b is located in the through hole a2, and brazed to the conductive layer 14a2. Thereby, the sleeve 27b is fixed to the insulating plate 11, and electrically connected to the conductive layer 14a2. The filament terminal 26b supports the other extension portion of the filament coil 21. The filament terminal 26b is fixed to and electrically connected to the sleeve 27b by resistance welding.

It should be noted that fixing (resistance welding) of the filament terminal 26a to the sleeve 27a and that of the filament terminal 26b to the sleeve 27b are achieved by making current flow in the filament terminals 26a and 26b after the filament coil 21 is positioned with respect to the groove portion 23a of the focusing electrode 23.

A voltage and current from a power supply unit located outside the X-ray tube 1 are applied and supplied to the cathode pins 16a and 16b, and then to the filament coil 21. Thereby, the filament coil 21 emits electrons (thermal electrons). The above power supply unit also applies a predetermined voltage to the anode target 3. Since an X-ray tube voltage (tube voltage) is applied between the anode target 3 and the cathode 2, electrons emitted from the filament coil 21 are accelerated and incident upon the target surface 3b as an electron beam. That is, an X-ray tube current (tube current) flows from the cathode 2 to a focal spot on the target surface 3b.

Furthermore, the power supply unit applies a voltage to the cathode pin 16c, as a result of which the voltage is applied to the focusing electrode 23. Thereby, the focusing electrode 23 can focus an electron beam (electrons) which will travel from the filament coil 21 toward the anode target 3 through opening of the groove portion 23c.

X-rays are radiated from the target surface 3b upon incidence of the electron beam on the target surface 3b. To be more specific, X-rays radiated from the focal spot on the target surface 3b are radiated to the outside of the X-ray tube 1 after transmitted through the envelope 4.

The X-ray tube 1 according to the embodiment having the above structure comprises the cathode 2, the anode target 3 and the envelope 4. The cathode 2 comprises the insulating plate 11, the conductive lines 13, the pin assemblies 15, the filament coil 21, the focusing electrode 23 and the terminal assemblies 25. The conductive lines 13 are formed of metal and provided on the insulating plate 11. The conductive lines 13 form part of a circuit of the cathode 2.

The pin assemblies 15 include the cathode pins 16, which are conductive, and the sleeves 17. The sleeves 17 are conductive, are fixed to the insulating plate 11, guide the cathode pin 16, are fixing the cathode pin 16, and are electrically connect the cathode pins 16 to the conductive lines 13. The sleeve 17a electrically connects the cathode pin 16a to the conductive line 13a. The sleeve 17b electrically connects the cathode pin 16b to the conductive line 13b. The sleeve 17c electrically connects the cathode pin 16c to the conductive line 13c.

The terminal assemblies 25 are conductive, are fixed to the insulating plate 11, support the filament coil 21, and electrically connect the filament coil 21 to the conductive lines. The terminal assembly 25a electrically connects the filament coil 21 to the conductive line 13a; and the terminal assembly 25b electrically connects the filament coil 21 to the conductive line 13b.

The pin assembly 15a and the terminal assembly 25a are connected by the conductive line 13a, which is formed on the insulating plate 11. The pin assembly 15b and the terminal assembly 25b are connected by the conductive line 13b, which is formed on the insulating plate 11. Thus, it is not necessary to use metallic thin wire (or metallic foil band) to connect the pin assembly 15a and the terminal assembly 25a. Also, it is not necessary to use metallic thin wire (or metallic foil band) to connect the pin assembly 15b and the terminal assembly 25b. Accordingly, it is possible to save a labor for connecting the pin assemblies 15 and the terminal assemblies 25, which is required in the case where the pin assemblies 15 and the terminal assemblies 25 are connected by metallic thin wires (or metallic foil bands). Therefore, the cathode 2 can be very simply assembled. Furthermore, it is possible to prevent generation of a foreign matter, which would generate in the case where metallic thin wires (or metallic foil bands) are resistance-welded to the pin assemblies 15 and the terminal assemblies 25.

In addition, since it is not necessary to weld metallic thin wires (or metallic foil bands) to the pin assemblies 15 and the terminal assemblies 25, it is possible to prevent current and heat necessary for welding from being added to the terminal assemblies 25 (the filament terminals 26). It is therefore also possible to restrict occurrence of problems such as deformation of the filament coil 21, displacement of the filament coil 21, and contact of the focusing electrode 23 with the filament coil 21.

By virtue of the above structural features, it is possible to obtain an X-ray tube 1 which can be more simply manufactured. Alternatively, it is possible to obtain X-ray tube 1 whose manufacturing yield is high.

(First Modification)

A first modification of the X-ray tube 1 according to the above embodiment will be explained.

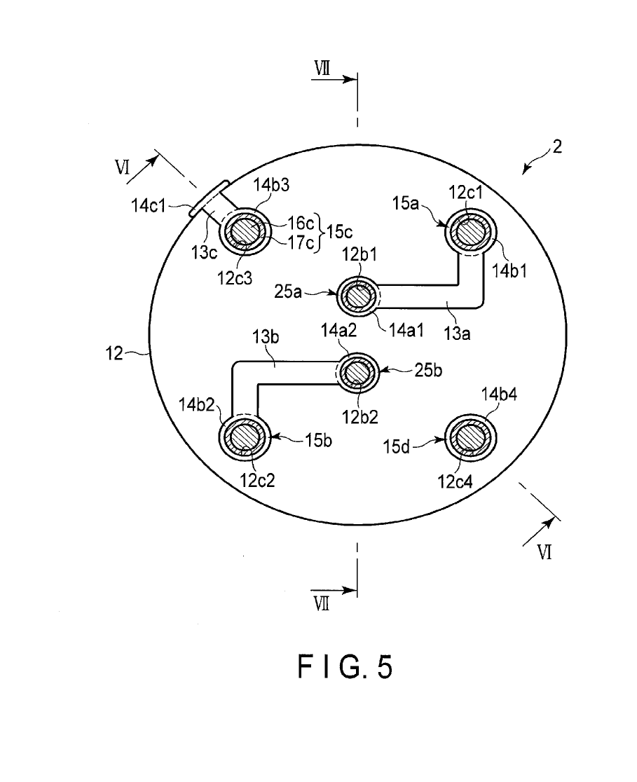

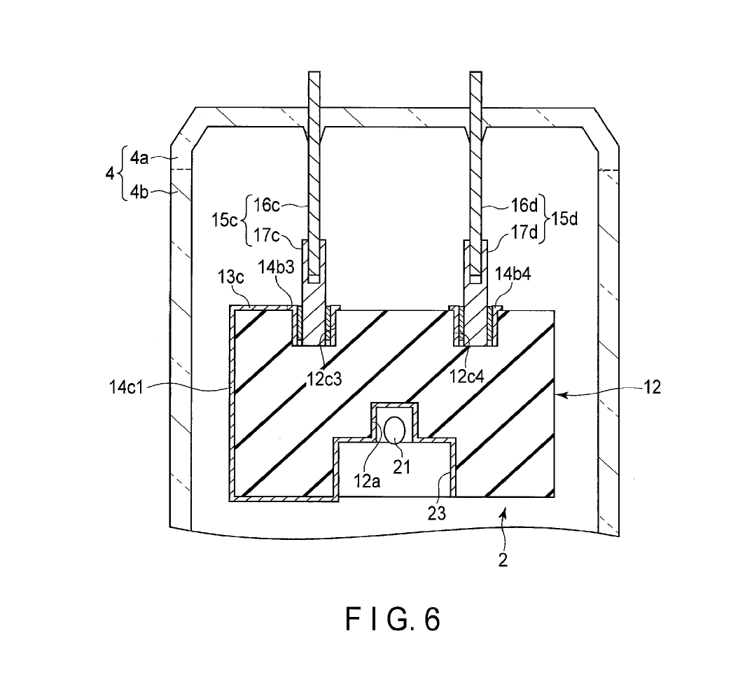

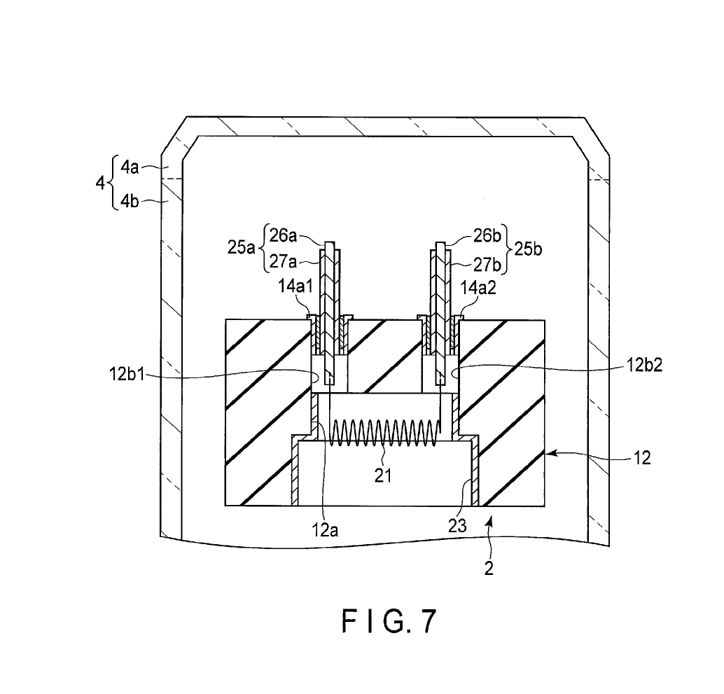

As shown in FIGS. 5 to 7, roughly speaking, the first modification is different from the above embodiment on the following points: in the first modification, a cathode 2 includes an insulating member 12 instead of the insulating plate 11, and a focusing electrode 23 has a different shape from that of the focusing electrode 23 of the embodiment.

The insulating member 12 is formed of an insulating material, for example, insulating ceramic; and is formed cylindrically. In the insulating member 12, a groove portion 12a, hole portions 12b and opening portions 12c are formed. The hole portions 12b and the opening portions 12c are separated from each other. The groove portion 12a is open on an anode target side where an anode target 3 is located. The groove portion 12a is shaped in accordance with the shape of a filament coil 21. In the first modification, the groove portion 12a extends in parallel with the filament coil 21. It should be noted that the filament coil 21 is located apart from an inner surface (bottom surface) of the groove portion 12a. In the groove portion 12a, the filament coil 21 is provided.

To be more specific, in the first modification, the insulating member 12 includes two hole portions 12b1 and 12b2 for terminal assemblies 25 and four opening portions 12c1, 12c2, 12c3 and 12c4 for pin assemblies 15. The hole portions 12b1 and 12b2 communicate with the groove portion 12a. In the hole portions 12b1 and 12b2, the terminal assemblies 25 and extension portions which are end portions of the filament coil 21 are located.

Conductive lines 13 and conductive layers 14 are formed of metal and located on the insulating member 12. The conductive layers 14 include conductive layers 14a1, 14a2, 14b1, 14b2, 14b3 and 14b4 which are formed in the hole portions 12b1 and 12b2 and the opening portions 12c1, 12c2, 12c3 and 12c4, and a conductive layer 14c1 formed on an outer peripheral wall of the insulating member 12. The conductive layers 14a1, 14a2, 14b1, 14b2, 14b3 and 14b4 continuously extend from inner peripheral walls of the opening portions and hole portions to a surface of the insulating member 12. It should be noted that the above surface of the insulating member 12 faces the lid portion 4a. The conductive layer 14c1 is located close to the conductive layer 14b3. The conductive lines 13 include conductive lines 13a, 13b and 13c. The conductive layer 14c1 electrically connects the conductive line 13c to the focusing electrode 23. Before the pin assemblies 15 and the terminal assemblies 25 are attached to the insulating member 12, the conductive lines 13 and the conductive layers 14 are formed on the insulating member 12 in advance. The focusing electrode 23 is formed in the shape of a film. The focusing electrode 23 is formed in the groove portion 12a. In the first modification, the focusing electrode 23 is continuously formed from an inner peripheral wall of the groove portion 12a to a bottom wall thereof. Also, the focusing electrode 23 is formed of, for example, a metalized layer which will be described in detail later.

Sleeves 17 of the pin assemblies 15 are provided in the opening portions 12c, and brazed to the conductive layers 14b. Thereby, the sleeves 17 are fixed to the insulating member 12, and electrically connected to the conductive layers 14b.

Sleeves 27 of the terminal assemblies 25 are provided in the hole portions 12b, and brazed to the conductive layers 14a. Thereby, the sleeves 27 are fixed to the insulating member 12, and electrically connected to the conductive layers 14a.

It should be noted that fixing (resistance welding) of filament terminals 26 to the sleeves 27 is carried out by making current flow in the filament terminals 26, after the filament coil 21 is positioned with respect to the focusing electrode 23.

The X-ray tube 1 according to the first modification having the above structure also has the same advantage as the X-ray tube 1 according to the above embodiment.

(Second Modification)

A second modification of the X-ray tube 1 according to the above embodiment will be explained.

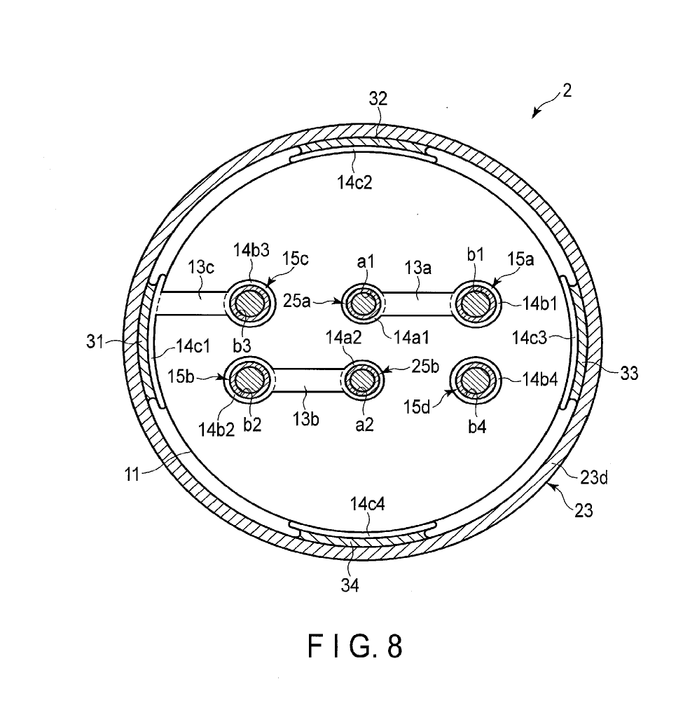

As shown in FIG. 8, roughly speaking, the second modification is different from the above embodiment with respect to the positions of the through holes b1, b2, b3 and b4 and the shapes of the conductive lines 13a, 13b and 13c.

Through holes a1, b1 and b3 are located on the same line. Also, through holes a2, b2 and b4 are located on the same line. The conductive lines 13a, 13b and 13c are linearly formed.

Conductive layers 14 include conductive layers 14a1, 14a2, 14b1, 14b2, 14b3, 14b4, 14c1, 14c2 and 14c3, and further include a conductive layer 14c4 formed on an outer peripheral wall of an insulating plate 11. The conductive layers 14c1, 14c2, 14c3 and 14c4 are separated from each other.

A focusing electrode 23 is fixed to the insulating plate 11 at four positions by brazing using solder member 31, 32, 33 and 34. For example, the solder member 34 is located between an annular portion 23d and the conductive layer 14c4, and soldered to the annular portion 23d and the conductive layer 14c4.

Before attaching pin assemblies 15 and terminal assemblies 25 to an insulating plate 11, and also before fixing a focusing electrode 23 to the insulating plate 11, the conductive lines 13 and conductive layers 14 are formed in advance on the insulating plate 11.

The X-ray tube 1 according to the second modification having the above structure also has the same advantage as the X-ray tube 1 according to the above embodiment.

(Third Modification)

A third modification of the X-ray tube 1 according to the above embodiment will be explained.

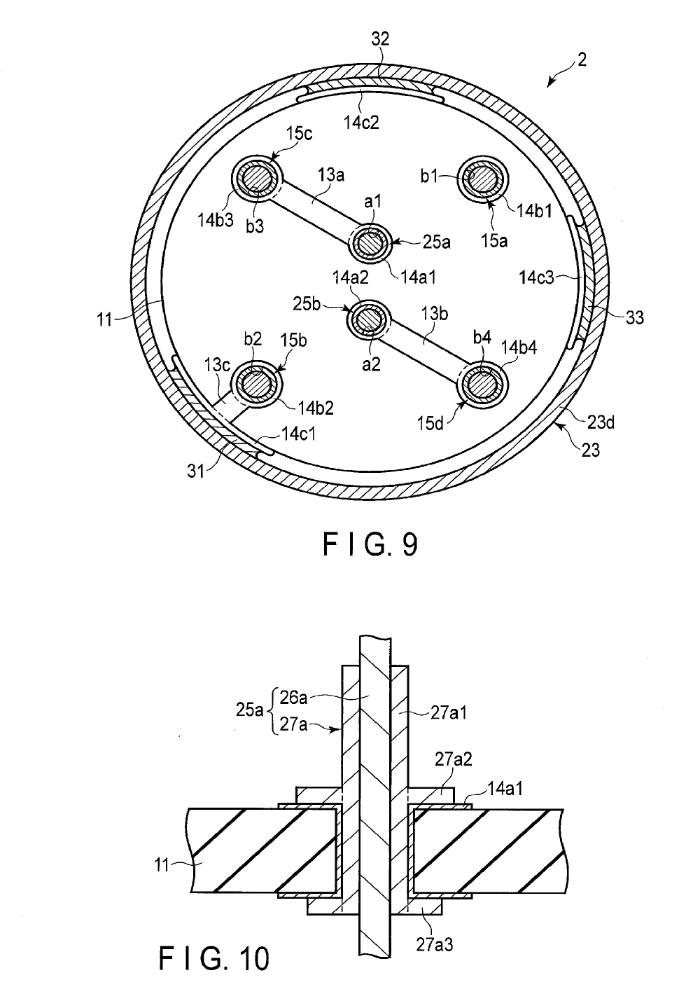

As shown in FIG. 9, roughly speaking, the third modification is different from the above embodiment with respect to the connections and shapes of the conductive lines 13, the positions of the conductive layers 14c1, 14c2 and 14c3, and the positions of the solder members 31, 32 and 33.

The conductive layer 14c1 is located close to a conductive layer 14b2. The conductive layers 14c1, 14c2 and 14c3 are separated from each other.

A conductive line 13a is connected to conductive layers 14a1 and 14b3. A conductive line 13b is connected to conductive layers 14a2 and 14b4. A conductive line 13c is connected to conductive layers 14b2 and 14c1. The conductive lines 13a, 13b and 13c are linearly formed.

Before attaching pin assemblies 15 and terminal assemblies 25 to an insulating plate 11, and also before fixing a focusing electrode 23 to the insulating plate 11, the conductive lines 13 and conductive layers 14 are formed in advance on the insulating plate 11.

The X-ray tube 1 according to the third modification having the above structure also has the same advantage as the X-ray tube 1 according to the above embodiment.

(Fourth Modification)

A fourth modification of the X-ray tube 1 according to the above embodiment will be explained.

As shown in FIG. 10, roughly speaking, the fourth modification is different from the above embodiment with respect to the method of fixing the sleeves 27 to the insulating plate 11. The sleeves 27 are crimped in the insulating plate 11.

To be more specific, for example, a sleeve 27a of a terminal assembly 25a includes a tubular portion 27a1, a collar portion 27a2 and a stop portion 27a3. The collar portion 27a2 is formed in the shape of a ring, and fixed to an outer peripheral surface of the tubular portion 27a1. In the fourth modification, the tubular portion 27a1 and the collar portion 27a2 are formed integral with each other. The stop portion 27a3 is formed in the shape of a ring, and fixed to a distal end portion of the tubular portion 27a1. In the fourth modification, the tubular portion 27a1 and the stop portion 27a3 are formed integral with each other. The stop portion 27a3 is plastically deformed. The collar portion 27a2 and the stop portion 27a3 are pressure-welded to a conductive layer 14a1. Thus, the sleeve 27a is fixed to the insulating plate 11, and electrically connected to the conductive layer 14a1.

The X-ray tube 1 according to the fourth modification having the above structure also has the same advantage as the X-ray tube 1 according to the above embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the conductive lines 13 may be formed as the same material as the conductive layers 14 or may be formed of a different material from that of the conductive layers 14. In any case, it suffices that the conductive lines 13 and the conductive layers 14 are formed of material having a conductive property.

The conductive lines 13 may be formed of well-known metalized layers.

Metalized layers are formed on a base-plate of ceramics as following steps.

First, the base-plate is coated or printed with the paste including a refractory metal, like molybdenum, as a main component.

Then, coated or printed base-plate is fired in furnace.

In general, when a metal part is brazed to a ceramic part, metalized layers are formed on the ceramic part as an interposing member.

Alternatively, the conductive lines 13 may be formed as follows:

The conductive lines 13 may be formed of metalized layers and solder members formed on the metalized layers;

The conductive lines 13 may be formed of metalized layers, metal foils and solder members which solder the metal foils to the metalized layers;

The conductive lines 13 may be formed of metalized layers and metallic layers which are formed on the metalized layers by evaporation; and

The conductive lines 13 may be formed by a well-known technique other than the above techniques.

The sleeves 17 of the pin assemblies 15 may be crimped in the insulating plate 11.

The filament terminals 26 may be fixed to and electrically connected to the sleeves 27 by tungsten inert gas (TIG) soldering.

The focusing electrode 23 may be fixed to the insulating plate 11 by thread-fastening. In this case, a through hole which allows a screw to be passed therethough is formed in the focusing electrode 23, and a screw hole is formed in the insulating plate 11.

Alternatively, the focusing electrode 23 may be crimped in the insulating plate 11.

The filament of the embodiment is not limited to the filament coil 21; that is, as the filament, various kinds of filaments such as a plate filament can be applied. It should be noted that the plate filament is a filament formed in the shape of a plate including a flat electron radiation surface.

The above embodiment is not limited to the above stationary anode X-ray tube, and can be applied to various kinds of stationary anode X-ray tubes and rotation anode X-ray tubes.

What is claimed is:

1. An X-ray tube comprising:
a cathode including: an insulating member; a conductive line formed of metal and formed on the insulating member; a pin assembly including a pin having a conductive property and a first sleeve which has a conductive property, is fixed to the insulating member, guides the pin, is fixing the pin, and electrically connects the pin to the conductive line; a filament configured to emit electrons; a focusing electrode configured to focus the electrons emitted from the filament; and a terminal assembly having a conductive property, fixed to the insulating member, supporting the filament, and electrically connecting the filament to the conductive line;
an anode target with which the electrons emitted from the cathode collide to generate X-rays; and
an envelope which accommodates the insulating member, the conductive line, the first sleeve, the filament, the focusing electrode, the terminal assembly and the anode target, and to which the pin is attached.

2. The X-ray tube of claim 1, wherein the terminal assembly includes: a terminal having a conductive property and supporting the filament; and a second sleeve which has a conductive property, is fixed to the insulating member, guides the terminal, is fixing the terminal, and electrically connects the terminal to the conductive line.

3. The X-ray tube of claim 1, wherein
the insulating member includes a groove portion in which the filament is provided, and a hole portion which communicates with the groove portion and in which the terminal assembly is located, and
the focusing electrode is formed in the groove portion.

4. The X-ray tube of claim 1, wherein the pin is connected to the first sleeve by welding.
